(19) United States
(12) Patent Application Publication
(10) Pub. No.: US 2024/0403181 A1
(43) Pub. Date: Dec. 5, 2024

(54) DETECTING AND PREDICTING ELECTRONIC STORAGE DEVICE DATA ANOMALIES

(71) Applicant: International Business Machines Corporation, Armonk, NY (US)

(72) Inventors: Fan Jing Meng, Beijing (CN); Hua Ye, Beijing (CN); Hong Xin Hou, Shanghai (CN); Ze Ming Zhao, Beijing (CN); Xiao Tian Xu, Chang De (CN); Jin Chi He, Xian (CN); Peng Li, Xian (CN)

(21) Appl. No.: 18/204,707

(22) Filed: Jun. 1, 2023

(51) Int. Cl. G06F 11/30; G06F 11/34

(52) U.S. Cl. CPC G06F 11/3034; G06F 11/3072; G06F 11/3428

(57) ABSTRACT

A computer-implemented method, a system and a computer program product for device failure detection are disclosed. In the method, phase-based predictions may be performed on a plurality of storage devices to determine a plurality of sampling scopes and corresponding sampling ratios. The respective sampling scopes may comprise at least one storage device of the plurality of storage devices. A sampling dataset may be obtained by selecting a group of storage devices from the respective sampling scopes with the corresponding sampling ratios. Device failure may be detected for the group of storage devices based on the sampling dataset.

### BACKGROUND

The present invention relates to data processing, and more specifically, to detecting electronic storage device anomalies.

For enterprise/organization, data is an asset and is growing at an exponential rate. Data is usually stored in storage devices, for example, Hard Disk Drives (HDD), Solid State Drives (SSD), Tape on-premise or on the cloud, or the like. However, failures of storage devices cause many negative impacts such as data loss, service unavailability, additional operational cost, economic loss, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one embodiment of the present invention, there is provided a computer-implemented method for device failure detection. In the method, phase-based predictions may be performed on a plurality of storage devices to determine a plurality of sampling scopes and corresponding sampling ratios. The respective sampling scopes may comprise at least one storage device of the plurality of storage devices. A sampling dataset may be obtained by selecting a group of storage devices from the respective sampling scopes with the corresponding sampling ratios. Device failure may be detected for the group of storage devices based on the sampling dataset.

Therefore, effective balance of accuracy, performance, and cost of failure detection of storage devices may be provided.

In some embodiments, performing the phase-based predictions on the plurality of storage devices may comprise: performing the phase-based predictions based on real time monitoring data associated with the plurality of storage devices and a plurality of models. The respective models are trained with benchmark data and historical monitoring data associated with the plurality of storage devices. Therefore, historical monitoring data and benchmark data including open data for specific manufacturers, models, and batches via supervised or unsupervised algorithms can be employed to facilitate the detections.

In some embodiments, the phase-based predictions comprise at least two phases of predictions. A next phase of prediction is performed based on a result of a previous phase of prediction. Therefore, prediction scopes and costs can be reduced with adequate features.

In some embodiments, performing the phase-based predictions on the plurality of storage devices further comprises the following phases. In a first phase, an environment anomaly can be predicted on the plurality of storage devices, to determine a first sampling scope with a first sampling ratio. The first sampling scope comprises the storage devices in normal environments. In a second phase, a performance anomaly can be predicted on the storage devices in abnormal environments, to determine a second sampling scope with a second sampling ratio. The second sampling scope comprises the storage devices in abnormal environments and performing normal. In a third phase, a device monitoring data anomaly can be predicted on the storage devices in abnormal environments and performing abnormal, to determine a third sampling scope with a third sampling ratio and a fourth sampling scope with a fourth sampling ratio. The third scope comprises storage devices in abnormal environments, performing abnormal and having normal device monitoring data. The fourth scope comprises storage devices in abnormal environments, performing abnormal and having abnormal device monitoring data. Further, the first sampling ratio is lower than the second sampling ratio, which is lower than the third sampling ratio, which is lower than the fourth sampling ratio. Therefore, different sampling scope can be assigned with different sampling ratio, to filter high risk devices for further detailed device failure prediction.

In some embodiments, the steps of performing, obtaining, and detecting can be implemented for a plurality of times, wherein the step of performing is scheduled based on a scheduling policy. Therefore, the predictions can be performed on demand based on dynamic scheduling policies and recent detection results.

In some embodiments, a failure base can be generated based on the detected device failure. Therefore, the failure base can be built and maintained to save detected anomalies for active sampling.

In some embodiments, a scheduling need can be evaluated based on the failure base, the benchmark data, and the historical monitoring data. The scheduling policy can be selected based on the scheduling need. Therefore, the prediction can be dynamically adjusted based on actual needs.

In some embodiments, the respective models are scheduled to be updated based on the scheduling need. Therefore, the respective models can be dynamically updated based on actual needs.

In some embodiments, the step of detecting the device failure for the group of storage devices based on the sampling dataset may comprise detecting the device failure based on real time monitoring data associated with the group of storage devices and a plurality of device failure prediction models. The respective device failure prediction models are trained with benchmark data and historical monitoring data associated with the plurality of storage devices. Therefore, historical monitoring data and benchmark data including open data for specific manufacturers, models, and batches via supervised or unsupervised algorithms can be employed to facilitate the detection.

According to another embodiment of the present invention, there is provided a system for device failure detection. The system may comprise one or more processors, a memory coupled to at least one of the one or more processors, and a set of computer program instructions stored in the memory. The set of computer program instructions may be executed by at least one of one or more processors to perform the above methods.

According to another embodiment of the present invention, there is provided a computer program product for device failure detection. The computer program product may comprise a computer readable storage medium having program instructions embodied therewith. The program instructions executable by one or more processors causes the one or more processors to perform the above methods.

In addition to the exemplary aspects and embodiments described above, further aspects and embodiments will become apparent by reference to the drawings and by study of the following descriptions.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 is an exemplary computing environment which is applicable to implement the embodiments of the present disclosure.

FIG. 2 is an exemplary device failure detection system according to embodiments of the present disclosure.

FIG. 3 is an exemplary process for device failure detection according to embodiments of the present disclosure.

FIG. 4 shows an exemplary process for phase-based predictions according to embodiments of the present disclosure.

FIG. 5 shows an exemplary block diagram of a scheduler module according to embodiments of the present disclosure.

FIG. 6 shows an exemplary flowchart of a computer-implemented method for device failure detection according to embodiments of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as device failure detection system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

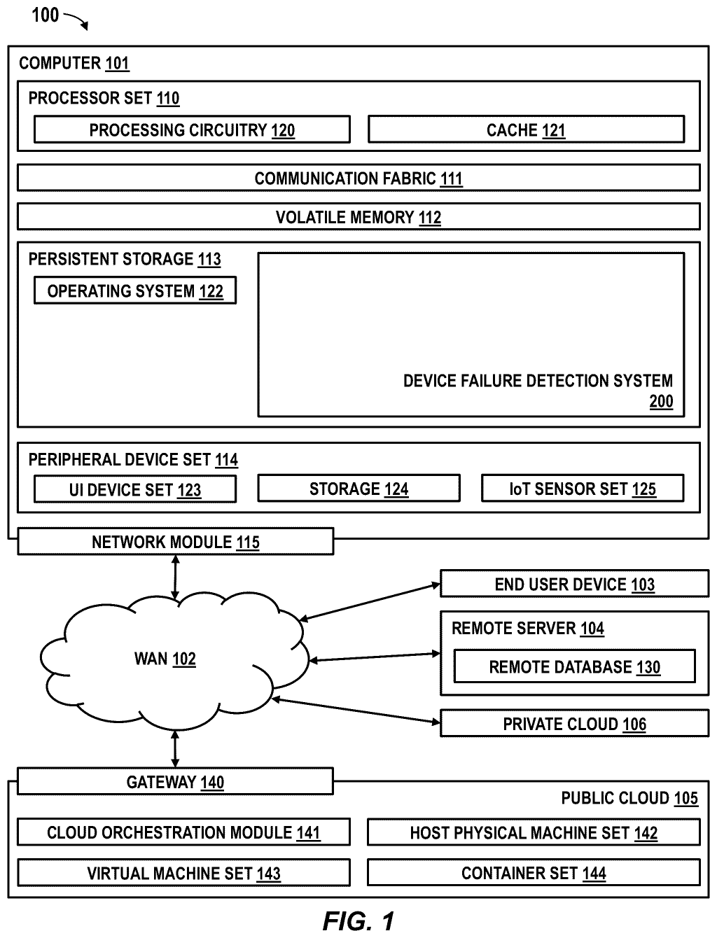

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is only provided for illustration purpose without suggesting any limitation to any embodiment of this invention, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device 114 could also be implemented by an independent peripheral device connected to the computer 101 through interface. For a further example, the WAN may be replaced and/or supplemented by any other connection made to an external computer (for example, through the Internet using an Internet Service Provider).

Generally, failure detections (or anomaly predictions) of massive storage devices are costly and time-consuming, due to a large scale of monitoring data and large-scale deployment in production. Approaches of predicting device failures may comprise threshold-based approaches (which set thresholds based on selected metrics), statistics-based approaches (which build statistics models on selected metrics), learning-based approaches (which build machine learning or deep learning models based on given features to predict anomalies or life span). However, most existing approaches more focus on the accuracy of the approaches. Few efforts address real-world challenges with massive storage devices with a balance of accuracy, performance, and cost.

Embodiments of the present disclosure provide a device failure detection system for detecting/predicting anomalies/failures of a large scale of storage devices. Based on the embodiments, effective balance of accuracy, performance and cost of failure detection of storage devices can be achieved. Detection scope and resources allocated for detection module can be reduced. In addition, more time and cost in detecting anomalous storage devices can be saved.

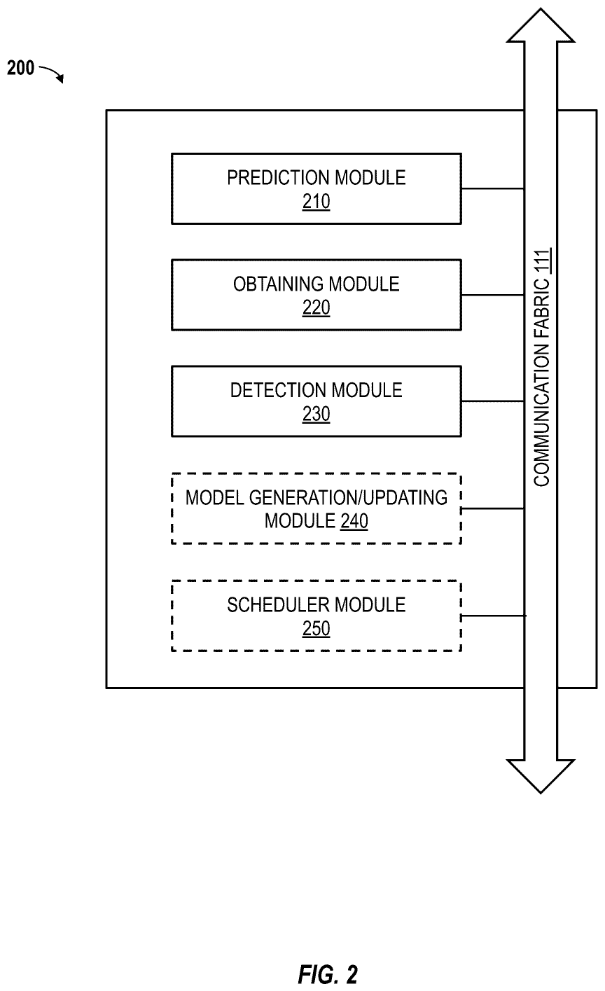

With reference now to FIG. 2, a block diagram is provided illustrating an exemplary device failure detection system 200 according to some embodiments of the present disclosure.

It should be noted that the processing of the device failure detection system 200 according to embodiments of this disclosure could be implemented in the computing environment of FIG. 1.

As depicted in FIG. 2, in some embodiments, the device failure detection system 200 may comprise a prediction module 210, an obtaining module 220, a detection module 230. In further embodiments, the device failure detection system 200 may also comprise a model generation/updating module 240, a scheduler module 250, and/or the like. All, or some, of the modules may be configured to communicate with each other (e.g., via the communication fabric 111 as depict in FIG. 1, such as a bus, shared memory, a switch, or a network). Any one or more of these modules may be implemented using the processing circuitry 120 in FIG. 1 (e.g., by configuring the processing circuitry 120 to perform functions described for that module). It can be noted that, the addition, removal and/or modification of one or more modules can be configured based on actual needs.

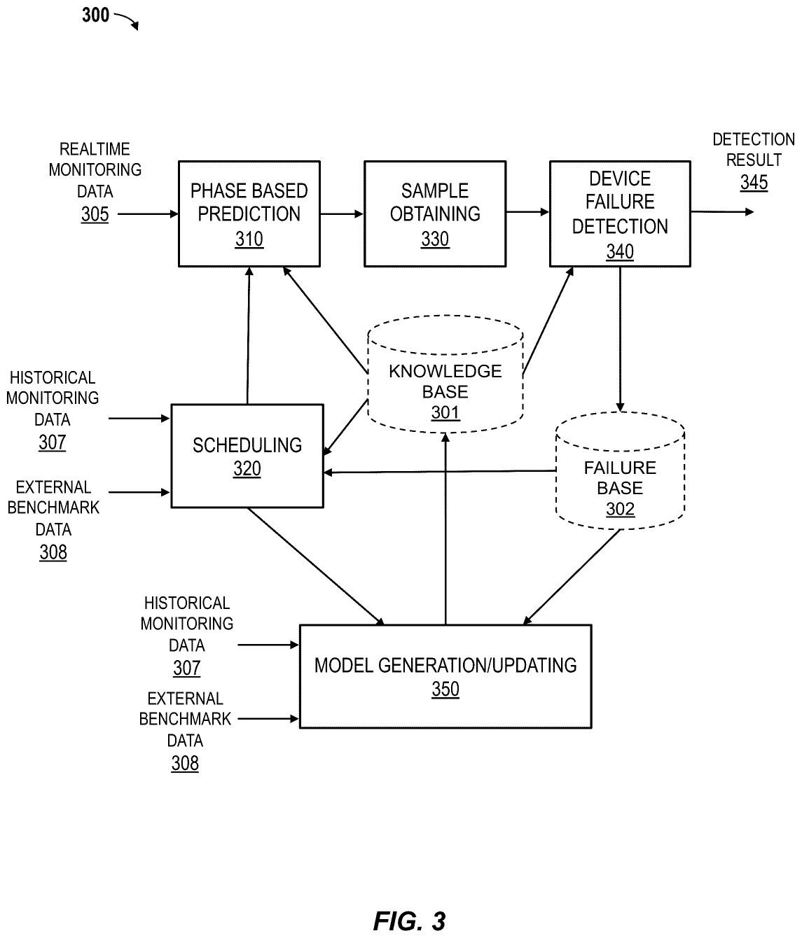

FIG. 3 depicts an exemplary process 300 for device failure detection according to embodiments of this disclosure. The process 300 can be implemented with the device failure detection system 200 and will be described in connection with FIG. 2 below.

At block 310, the prediction module 210 may perform phase-based predictions on a plurality of storage devices to determine a plurality of sampling scopes and corresponding sampling ratios. The respective sampling scope may comprise at least one storage device of the plurality of storage devices.

In some embodiments, the storage devices may be at least one of HDD, SSD, memory cards, floppy discs, optical disc drives (Compact Disk (CD), Digital Versatile Disc (DCD, Blu-Ray DVD)), RAM, ROM and/or the like. Moreover, the respective storage devices may be associated with a set of monitoring data, for example, environmental data, performance data, device monitoring data, meta data, and maintenance data, and/or the like.

As examples, the environmental data may comprise metrics for operational environments (for example, a server room, a row, a rack, etc.) of the storage devices, such as, temperature, humidity, air qualities, and/or the like. The performance data may reflect performance of applications deployed on the storage devices. For example, the performance data may comprise Input/Output Operations Per Second (IOPS), Mean Time between Failures (MTBF), Mean time to repair (MTTR), read/write speed, and/or the like. The device monitoring data may comprise Self-Monitoring Analysis and Reporting Technology (SMART) data, indicating metrics of attributes of HDDs and SSDs, such as, read error rate, start/stop count, drive calibration retry count, etc. Other kinds of device monitoring data known in the art can also be included for other kinds of storage devices. Moreover, the meta data may comprise vendors, types, sizes, ages, and/or the like, of the storage devices. The maintenance data may comprise maintenance logs related to the storage devices. As can be understood, any other appropriate monitoring data associated with the storage devices can also be obtained based on actual needs.

Therefore, the prediction module 210 may receive a large scale of monitoring data associated with the plurality of storage device in real time. The received monitoring data may also be referred to as real time monitoring data 305. Thus, the phase-based predictions can be performed based on the real time monitoring data 305. Generally, the real time monitoring data 305 are of great help for predicting storage device failure, especially the SMART data. However, the volume of such real time monitoring data 305 is too large to determine an efficient prediction. The phase-based prediction, in the embodiments, can help filtering most useful data for further prediction/detection.

In some embodiments, the prediction module 210 may perform the phase-based predictions by means of a plurality of anomaly prediction models based on the real time monitoring data. For example, the anomaly prediction model may comprise environmental anomaly prediction models, performance anomaly prediction models, device monitoring data anomaly prediction models, and/or the like. Further, the respective anomaly prediction models may be at least one of a classification model, a regression model, a clustering model, a heuristic model. As can be understood, any other appropriate models known in the art can also be implemented based on actual needs.

In an instance, the environmental anomaly prediction models may be configured to predict whether the storage devices are deployed in abnormal environments, such as, abnormal temperature, abnormal humidity, corrosive gases, and/or the like. For example, thresholds for temperature, humidity, and/or gas amount can be predefined. In another instance, the performance anomaly prediction models may be configured to predict whether the storage devices perform abnormally, or the applications distributed on the storage devices have abnormal performance. For example, the prediction of performance anomaly of the storage device may be made if the read/write speed is relatively slow, if the IOPS is dramatically reduced, or the MTTR is relatively high. For example, respective thresholds may be predefined with respect to the read/write speed, IOPS, or MTTR. In a yet instance, the device monitoring data anomaly prediction models (for example, SMART data anomaly prediction models) may be configured to predict abnormal attributes of the storage devices.

In some embodiments, the anomaly prediction models as discussed above may be pretrained and stored in a knowledge base 301. Alternatively, the model generation/updating module 240 may generate the anomaly prediction models from external benchmark database and historical monitoring database of the plurality of storage devices at block 350. Specifically, the external benchmark database may store open-source data for storage devices of specific manufacturers, models, and batches via supervised or unsupervised algorithms. Moreover, the historical monitoring database may store historical monitoring data 307 associated with the storage devices, such as environmental data, performance data, device monitoring data, meta data and maintenance data, and/or the like. The historical monitoring data 307 may be similar to the real time monitoring data but are collected from historical data samplings. Repetitive descriptions for the historical monitoring data can be omitted herein. The generated anomaly prediction models can then be stored in the knowledge base 301.

Therefore, the prediction module 210 may access the pretrained or generated anomaly prediction models from the knowledge base 301 to determine the corresponding anomaly predictions.

Further, the phase-based predictions may be further performed based on a scheduling policy. For example, the scheduling policy may indicate, for specific storage devices, a prediction timing (also referred to as sampling timing), a prediction frequency (also referred to as sampling frequency), appropriate models to be adopted, an updating timing of the respective models, and/or the like. For example, in a case that the storage devices to be detected are critical, associated SLA requirements are at higher level, and/or the like, the prediction frequency may be predefined as a higher frequency. Moreover, appropriate models can be selected from the stored anomaly prediction models according to the scheduling policies based on actual needs.

In some embodiments, the scheduling policies may be predefined and stored in the knowledge base 301. For example, prediction module 210 may receive user input from a user specifying the scheduling policies based on practical experiences. Therefore, the scheduler module 250 may access the predefined scheduling policies from the knowledge base 301 to schedule the corresponding anomaly predictions at block 320.

Further, the scheduler module 250 may further schedule the updating of the stored anomaly prediction models based on the scheduling policies, which will be described below.

With the prediction process, storage devices with different failure possibility can be determined and thus can be classified into several sampling scopes. Each sampling scope may comprise a scope of storage devices of the plurality of storage devices, for example, storage devices in a same location (such as a server room, a rack, a row or the like), storage devices with similar performance or storage devices with similar device monitoring data. For example, in a case that a temperature of a first server room is abnormally high while a temperature of a second server room is normal, it may determine a sampling scope including the storage devices in the first server room, which may have a higher possibility to fail than another sampling scope including the storage devices in the second room.

Then, the respective sampling scope may be assigned with a corresponding sampling ratio. The sampling ratio may indicate a percentage of storage devices to be sampled in the sampling scope. In some embodiments, the sampling scope with high potential failure devices may be assigned with a higher sampling ratio than the sampling scope with low potential failure devices. As to the above example, the sampling scope including the storage devices in the first server room may be assigned with higher sampling ratio than the sampling scope including the storage devices in the second room.

In some embodiments, the phase-based predictions may comprise two or more phases of anomaly predictions performed sequentially. For example, a next phase prediction (for example, device monitoring data anomaly prediction) may be implemented based on a result of a previous phase prediction (for example, environment anomaly prediction). Therefore, high risk devices can be filtered for further detailed storage device failure prediction/detection.

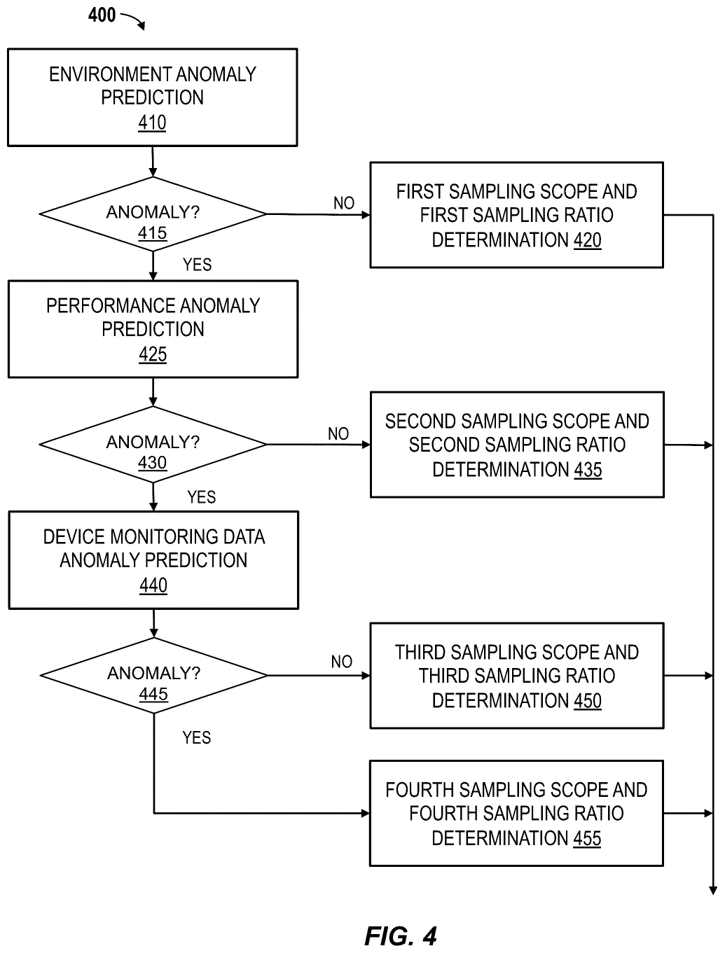

FIG. 4 depicts a flowchart of an exemplary process 400 for phase-based predictions according to some embodiments of the present disclosure.

In a first phase, at block 410, environment anomaly predictions may be performed on the plurality of storage devices via the environment anomaly prediction models, for example, based on the environmental data and meta data and maintenance data. It can be noted that, different environment anomaly prediction models can be used in this phase with respect to different kinds of storage devices. Thus, it can determine whether the respective storage devices are deployed in an abnormal environment or a normal environment at block 415. If the respective storage devices are deployed in a normal environment, at block 420, a first sampling scope comprising storage devices in normal environments can be determined. The first sampling scope can be assigned with a first sampling ratio, for example, a normal sampling ratio, such as 5%. Otherwise, the respective storage devices are deployed in an abnormal environment, then storage devices in abnormal environments can be further processed in a next phase prediction, i.e., a second phase.

In the second phase, at block 425, performance anomaly predictions may be performed on the storage devices in abnormal environments via the performance anomaly prediction models, for example, based on the performance data and meta data and maintenance data. It can be noted that, different performance anomaly prediction models can be used in this phase with respect to different kinds of storage devices. Thus, it can be determined whether the respective storage devices perform abnormally or normally at block 430. If the respective storage devices are performing normally, a second sampling scope which comprises storage devices in abnormal environments and with normal performance can be determined at block 435. A second sampling ratio may be assigned for the second sampling scope, which may be higher than the first sampling ratio, such as 20%. Otherwise, if the respective storage devices are performing abnormally, storage devices in abnormal environments and with abnormal performance can be further processed in a next phase prediction, i.e., a third phase.

In the third phase, at block 440, device monitoring data anomaly predictions may be performed on the storage devices in abnormal environments and with abnormal performance via the device monitoring data anomaly prediction models, for example, based on the device monitoring data and meta data and maintenance data. It can be noted that, different device monitoring data anomaly prediction models can be used in this phase with respect to different kinds of storage devices. Thus, it can be determined whether the device monitoring data of the respective storage devices are abnormal or normal at block 445. If the device monitoring data of the respective storage devices are normal, at block 450, a third sampling scope which comprises storage devices with abnormal environment, abnormal performance, and normal device monitoring data, can be determined. A third sampling ratio can be assigned for the third sampling scope, which may be higher than the second sampling ratio, such as 50%. Moreover, a fourth sampling scope can be determined which comprises storage devices with abnormal environment, abnormal performance, and abnormal device monitoring data at block 455. A fourth sampling ratio may be assigned for the fourth sampling scope, which may be still higher than the third sampling ratio, such as 100%.

Therefore, four sampling scope and corresponding sampling ratios determined by the prediction module 210 may be output to the obtaining module 220. Based on the above example, in the process 400, the fourth sampling scope may represent high risk storage devices and should be given more attention when performing the device failure detection, while the first sampling scope may represent low risky storage devices and can be given less attention for saving resources, reducing costs and improving efficiency.

As can be appreciated, the process 400 is described only for the purpose of illustration, other appropriate details (including addition, removal, modification of one or more blocks) can also be achieved in some other embodiments of the present disclosure. For example, the process 400 may comprise two or more phases. The sampling scopes can be further divided based on the monitoring data according to actual needs.

Back to FIG. 3, after the phase-based predictions process, the obtaining module 220 may obtain a sampling dataset by selecting a group of storage devices from the respective sampling scopes with the corresponding sampling ratios, at block 330.

In some embodiments, for each sampling scope, storage devices can be selected based on the corresponding sampling ratio, randomly. For example, if a sampling scope is assigned with a sampling ratio of 20%, then 20% of the storage devices in the sampling scope can be selected randomly. In such way, the group of storage devices may comprise the selected storage devices from each sampling scope. As can be understood, the group may comprise more high risk storage devices and less low risk storage devices.

With respect to the exemplary process 400 as discussed above, 5% storage devices of the first sampling scope, 20% storage devices of the second sampling scope, 50% storage devices of the third sampling scope, and 100% storage devices of the fourth sampling scope may be selected to form the group of storage devices to be further detected.

Accordingly, the sampling dataset may comprise the real time monitoring data associated with the group of storage devices. Thus, the detection scope can be narrowed from the plurality of storage devices to the group of storage devices within thereof, and the processing data can be reduced from the large scale of monitoring data to adequate features, i.e., the monitoring data associated with the group of storage devices. As the monitoring data required for prediction/detection is significantly reduced, the detection cost can be reduced while the detection efficiency can be improved. The process for generating the sampling dataset can be referred to as an active sampling process.

Then, at block 340, the detection module 230 may detect device failure for the group of storage devices based on the sampling dataset. In some embodiments, the detection module 230 may apply device failure prediction models to the sampling dataset. For example, the device failure prediction models may be at least one of a classification model, a regression model, a clustering model, a heuristic model.

Similar to the anomaly prediction models discussed above, the device failure prediction models may be pretrained and stored in the knowledge base 301. Alternatively, the model generation/updating module 240 may generate the device failure prediction models based on the external benchmark database and historical monitoring database of the plurality of storage devices at block 350. The respective models are trained with benchmark data 308 and historical monitoring data 307 associated with the plurality of storage devices. Repetitive descriptions can be omitted herein. The generated device failure prediction models can then be stored in the knowledge base 301. Therefore, the detection module 230 may access the pretrained or generated failure prediction models from the knowledge base 301 to determine the failure detection.

Further, the device failure detection may be also performed based on scheduling policies. For example, the scheduling policies may indicate, for specific storage devices, appropriate device failure prediction models to be adopted, an updating timing of the respective models, and/or the like. The scheduling policies may be predefined and stored in the knowledge base 301. Therefore, the scheduler module 250 may access the predefined scheduling policies from the knowledge base 301 to determine the appropriate device failure prediction models with respect to the storage devices based on the scheduling policies. Further, the scheduler module 250 may further schedule the updating of the stored device failure prediction models based on the scheduling policies, which will be described below.

Therefore, the detection result 345 can be output for further operations, such as repairing the failed device, replacing the failed device with a new one, and/or the like.

In some embodiments, the detected device failure may be stored in a failure base 302. Moreover, the stored device failure may be labeled with a corresponding failure type. For example, the detected device failure may be classified into different failure type, for example, missing (it cannot establish a working I/O path to the disk), dead (disk responds but is non-functional), failing (disk has reported a SMART trip or uncorrected read error rate is too high), read only (disk can read but is unable to write particular sectors), slow (disk performance is low compared to its peers, and system will only read from the disk only if necessary to avoid data loss), and/or the like.

Therefore, the failure base 302 may be built and maintained to save the detected failures with corresponding failure types for further processing, for example, updating the corresponding models and policies.

In some embodiments, the model generation/updating module 240 may update the respective models stored in the knowledge base 301, based on the failure base 302, the historical monitoring database, the external benchmark database at block 350. The updated models can then be used for a next process of device failure detection. In some embodiments, the model updating can be scheduled by the scheduler module 250 based on scheduling policies.

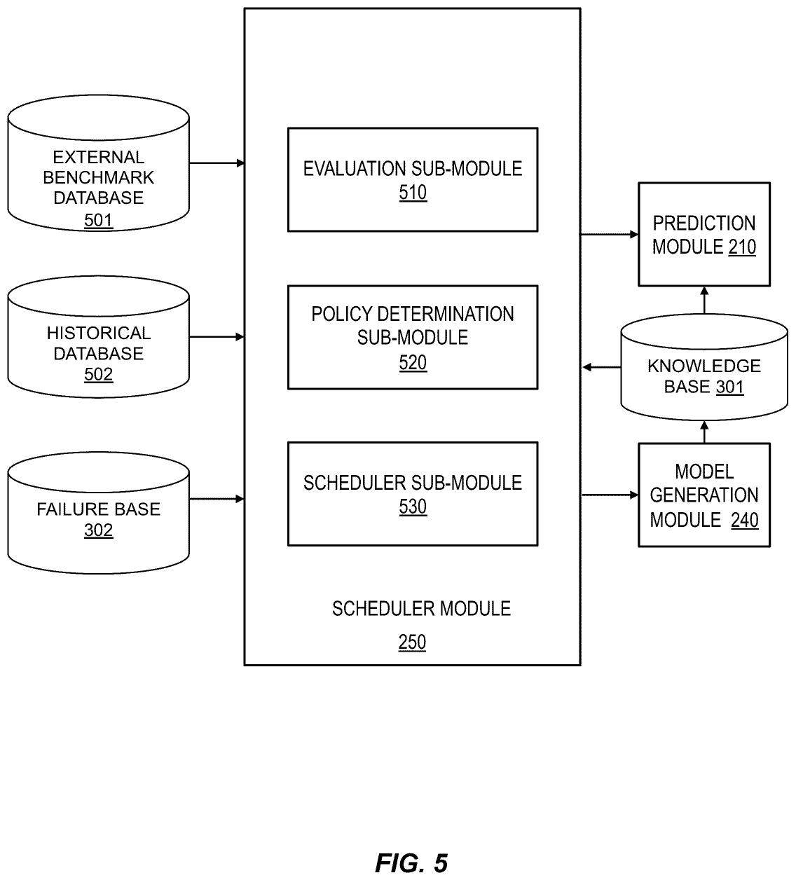

FIG. 5 depicts an exemplary block diagram of the scheduler module 250 according to embodiments of the present disclosure.

As shown in FIG. 5, in some embodiments, the scheduler module 250 may comprise an evaluation sub-module 510, a policy determination sub-module 520, a scheduler sub-module 530, and/or the like.

In some embodiments, the evaluation sub-module 510 may evaluate a scheduling need based on the failure base 302, the historical monitoring database 502, the external benchmark database 501. For example, the evaluation sub-module 510 may determine a normal failure rate of a certain kind of storage device from the external benchmark database 501 and the historical monitoring database 502. The evaluation sub-module 510 may also determine a detected failure rate of the certain kind of storage device from the failure base 302. Then, the evaluation sub-module 510 may compare the normal failure rate with the detected failure rate to obtain a difference value between them. If the difference value is higher than a preset threshold, the evaluation sub-module 510 may determine that there is a scheduling need to adjust the prediction frequency (or sampling frequency), updating the adopted models (anomaly prediction models, device failure prediction models), and/or the like.

For example, if the normal failure rate is 4% while the detected failure rate is 9%, the difference value is 5%, which is higher the preset threshold, for example, 3%. Thus, the scheduling need can be determined as an increased frequency of prediction, for example from once per day to twice per day. Moreover, the evaluation sub-module 510 may determine that the adopted models should be updated.

In some embodiments, the policy determination sub-module 520 may select a scheduling policy from the scheduling policies stored in the knowledge base 301, based on the scheduling need. For example, the scheduling policy may indicate a prediction timing (sampling timing), a prediction frequency (sampling frequency), abnormal prediction models/device failure prediction models to be adopted, the updating timing of the respective models, and/or the like.

Moreover, the scheduler sub-module 530 may schedule the prediction process based on the determined policy, for example, adjusting the prediction frequency (or sampling frequency). In addition, the scheduler sub-module 530 may schedule the updating of the respective models, for example, trigging the model generation/updating module 240 to update the respective models based on the detected device failure stored in the knowledge base 301, the historical monitoring database 502, and the external benchmark database 501.

Therefore, the respective models can be updated/retrained with new training data (for example, the detected device failure, new input from the historical monitoring database and the external benchmark database, or the like). Accordingly, the prediction/detection results can be dynamically adjusted. Efficiency of detection can be improved, thereby facilitating cost reduction and avoiding resource wastes.

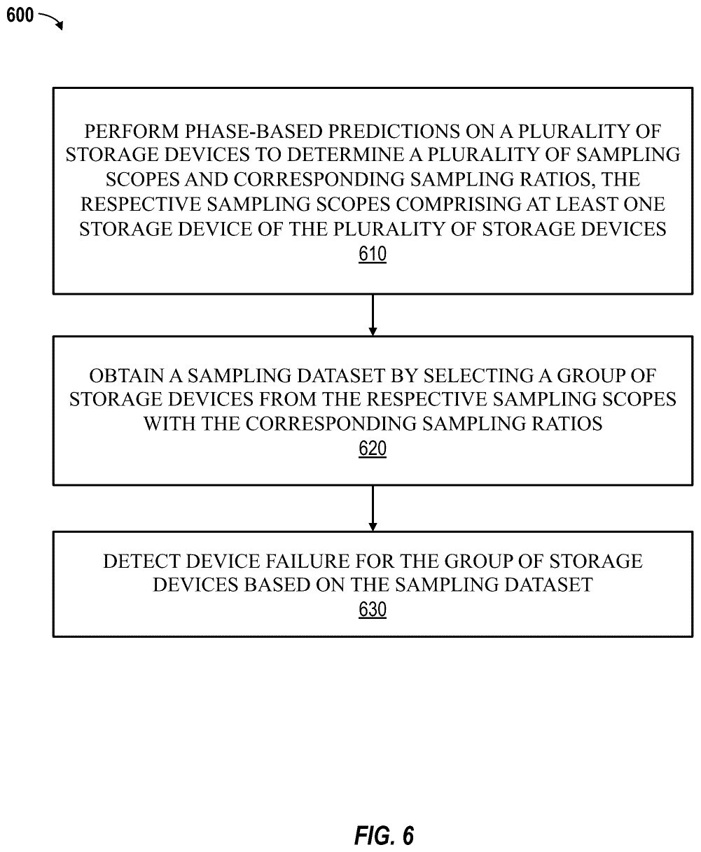

FIG. 6 depicts an exemplary flowchart of a method 600 for device failure detection according to embodiments of the present disclosure. The processing can be implemented by a computing device, such as a computer 101 shown in FIG. 1.

At block 610, the computing device may perform phase-based predictions on a plurality of storage devices to determine a plurality of sampling scopes and corresponding sampling ratios. The respective sampling scopes may comprise at least one storage device of the plurality of storage devices.

Therefore, effective balance of accuracy, performance, and cost of failure detection of storage devices may be provided.

In some embodiments, performing the phase-based predictions on the plurality of storage devices may comprise performing the phase-based predictions based on real time monitoring data associated with the plurality of storage devices and a plurality of models. The respective models are trained with benchmark data and historical monitoring data associated with the plurality of storage devices. Therefore, historical monitoring data and benchmark data including open data for specific manufacturers, models, and batches via supervised or unsupervised algorithms can be employed to facilitate the detections.

In some embodiments, the benchmark model may comprise at least two of the following models: environment anomaly prediction models, performance anomaly prediction models and SMART anomaly prediction models.

In some embodiments, the phase-based predictions comprise at least two phases of predictions. A next phase of prediction is performed based on a result of a previous phase of prediction. Therefore, prediction scopes and costs can be reduced with adequate features.

In some embodiments, performing the phase-based predictions on the plurality of storage devices further comprises the following phases. In a first phase, an environment anomaly can be predicted on the plurality of storage devices, to determine a first sampling scope with a first sampling ratio. The first sampling scope comprises the storage devices in normal environments. In a second phase, a performance anomaly can be predicted on the storage devices in abnormal environments, to determine a second sampling scope with a second sampling ratio. The second sampling scope comprises the storage devices in abnormal environments and performing normal. In a third phase, a device monitoring data anomaly can be predicted on the storage devices in abnormal environments and performing abnormal, to determine a third sampling scope with a third sampling ratio and a fourth sampling scope with a fourth sampling ratio. The third scope comprises storage devices in abnormal environments, performing abnormal and having normal device monitoring data. The fourth scope comprises storage devices in abnormal environments, performing abnormal and having abnormal device monitoring data. Further, the first sampling ratio is lower than the second sampling ratio, which is lower than the third sampling ratio, which is lower than the fourth sampling ratio. Therefore, different sampling scope can be assigned with different sampling ratio, to filter high risky devices for further detailed device failure prediction.

At block 620, the computing device may obtain a sampling dataset by selecting a group of storage devices from the respective sampling scopes with the corresponding sampling ratios.

At block 630, the computing device may detect device failure for the group of storage devices based on the sampling dataset.

In some embodiments, the steps of performing, obtaining, and detecting can be implemented for a plurality of times, and the step of performing is scheduled based on a scheduling policy. Therefore, the predictions can be performed on demand based on dynamic scheduling policies and recent detection results.

In some embodiments, a failure base can be generated based on the detected device failure. Therefore, the failure base can be built and maintained to save detected anomalies for active sampling.

In some embodiments, a scheduling need can be evaluated based on the failure base, the benchmark data and the historical monitoring data. The scheduling policy can be selected based on the scheduling need. Therefore, the prediction can be dynamically adjusted based on actual needs.

In some embodiments, the respective models are scheduled to be updated based on the scheduling need. Therefore, the respective models can be dynamically updated based on actual needs.

In some embodiments, the step of detecting the device failure for the group of storage devices based on the sampling dataset may comprise detecting the device failure based on real time monitoring data associated with the group of storage devices and a plurality of device failure prediction models. The respective device failure prediction models are trained with benchmark data and historical monitoring data associated with the plurality of storage devices. Therefore, historical monitoring data and benchmark data including open data for specific manufacturers, models, and batches via supervised or unsupervised algorithms can be employed to facilitate the detection.

It can be noted that, the sequence of the blocks described in the above embodiments are merely for illustrative purposes. Any other appropriate sequences (including addition, deletion, and/or modification of at least one block) can also be implemented to determine the corresponding embodiments.

Additionally, in some embodiments of the present disclosure, a system for device failure detection may be provided. The system may comprise one or more processors, a memory coupled to at least one of the one or more processors, and a set of computer program instructions stored in the memory. The set of computer program instructions may be executed by at least one of one or more processors to perform the above method.

In some other embodiments of the present disclosure, a computer program product for device failure detection may be provided. The computer program product may comprise a computer readable storage medium having program instructions embodied therewith. The program instructions executable by one or more processors causes the one or more processors to perform the above method.

The present invention may be a system, a method, and/or a computer program product at any possible technical detail level of integration. The computer program product may include a computer readable storage medium (or media) having computer readable program instructions thereon for causing a processor to carry out aspects of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
performing, by one or more processors, phase-based predictions on a plurality of storage devices to determine a plurality of sampling scopes and corresponding sampling ratios, wherein the respective sampling scopes comprise at least one storage device of the plurality of storage devices;
obtaining, by the one or more processors, a sampling dataset by selecting a group of storage devices from the respective sampling scopes with the corresponding sampling ratios; and
detecting, the by one or more processors, device failure for the group of storage devices based on the sampling dataset.

2. The computer-implemented method according to claim 1, wherein performing the phase-based predictions on the plurality of storage devices further comprises:
performing, by the one or more processors, the phase-based predictions based on real time monitoring data associated with the plurality of storage devices and a plurality of models, wherein the respective models are trained with benchmark data and historical monitoring data associated with the plurality of storage devices.

3. The computer-implemented method according to claim 2, wherein the phase-based predictions comprise at least two phases of predictions;
wherein a next phase of prediction is performed based on a result of a previous phase of prediction.

4. The computer-implemented method according to claim 3, wherein performing the phase-based predictions on the plurality of storage devices further comprises:
in a first phase, predicting, by the one or more processors, an environment anomaly on the plurality of storage devices, to determine a first sampling scope with a first sampling ratio, wherein the first sampling scope comprises the storage devices in normal environments;
in a second phase, predicting, by the one or more processors, a performance anomaly on the storage devices in abnormal environments, to determine a second sampling scope with a second sampling ratio, wherein the second sampling scope comprises the storage devices in abnormal environments and performing normal; and
in a third phase, predicting, by the one or more processors, a device monitoring data anomaly on the storage devices in abnormal environments and performing abnormal, to determine a third sampling scope with a third sampling ratio and a fourth sampling scope with a fourth sampling ratio, wherein the third scope comprises storage devices in abnormal environments, performing abnormal and having normal device monitoring data, and wherein the fourth scope comprises storage devices in abnormal environments, performing abnormal and having abnormal device monitoring data;
wherein the first sampling ratio is lower than the second sampling ratio, which is lower than the third sampling ratio, which is lower than the fourth sampling ratio.

5. The computer-implemented method according to claim 2, further comprising:
implementing, by the one or more processors, the steps of performing, obtaining, and detecting for a plurality of times, wherein the step of performing is scheduled based on a scheduling policy.

6. The computer-implemented method according to claim 5, further comprising:
generating, by the one or more processors, a failure base based on the detected device failure.

7. The computer-implemented method according to claim 6, further comprising:
evaluating, by the one or more processors, a scheduling need based on the failure base, the benchmark data and the historical monitoring data;
wherein the scheduling policy is selected based on the scheduling need.

8. The computer-implemented method according to claim 7, wherein the respective models are scheduled to be updated based on the scheduling need.

9. The computer-implemented method according to claim 1, wherein detecting the device failure for the group of storage devices based on the sampling dataset comprises:
detecting, by the one or more processors, the device failure based on real time monitoring data associated with the group of storage devices and a plurality of device failure prediction models, wherein the respective device failure prediction models are trained with benchmark data and historical monitoring data associated with the plurality of storage devices.

10. A computer system, comprising:
one or more computer processors;
a memory coupled to at least one of the processors; and
a set of computer program instructions stored in the memory and executed by at least one of the one or more computer processors in order to perform actions of:
performing phase-based predictions on a plurality of storage devices to determine a plurality of sampling scopes and corresponding sampling ratios, wherein the respective sampling scopes comprise at least one storage device of the plurality of storage devices;
obtaining a sampling dataset by selecting a group of storage devices from the respective sampling scopes with the corresponding sampling ratios; and
detecting device failure for the group of storage devices based on the sampling dataset.

11. The computer system according to claim 10, wherein performing the phase-based predictions on the plurality of storage devices further comprises:
performing the phase-based predictions based on real time monitoring data associated with the plurality of storage devices and a plurality of models, wherein the respective models are trained with benchmark data and historical monitoring data associated with the plurality of storage devices.

12. The system according to claim 11, wherein the phase-based predictions comprise at least two phases of predictions, wherein a next phase of prediction is performed based on a result of a previous phase of prediction.

13. The computer system according to claim 12, wherein performing the phase-based predictions on the plurality of storage devices further comprises:
in a first phase, predicting an environment anomaly on the plurality of storage devices, to determine a first sampling scope with a first sampling ratio, wherein the first sampling scope comprises the storage devices in normal environments;
in a second phase, predicting a performance anomaly on the storage devices in abnormal environments, to determine a second sampling scope with a second sampling ratio, wherein the second sampling scope comprises the storage devices in abnormal environments and performing normal; and
in a third phase, predicting a device monitoring data anomaly on the storage devices in abnormal environments and performing abnormal, to determine a third sampling scope with a third sampling ratio and a fourth sampling scope with a fourth sampling ratio, wherein the third scope comprises storage devices in abnormal environments, performing abnormal and having normal device monitoring data, and wherein the fourth scope comprises storage devices in abnormal environments, performing abnormal and having abnormal device monitoring data, wherein the first sampling ratio is lower than the second sampling ratio, which is lower than the third sampling ratio, which is lower than the fourth sampling ratio.

14. The computer system according to claim 11, wherein the actions further comprise:
implementing the steps of performing, obtaining, and detecting for a plurality of times, wherein the step of performing is scheduled based on a scheduling policy.

15. The computer system according to claim 11, wherein the actions further comprise:
generating a failure base based on the detected device failure.

16. The computer system according to claim 15, wherein the actions further comprise:
evaluating a scheduling need based on the failure base, the benchmark data and the historical monitoring data;
wherein the scheduling policy is selected based on the scheduling need; and
wherein the respective models are scheduled to be updated based on the scheduling need.

17. The computer system according to claim 11, wherein detecting the device failure for the group of storage devices based on the sampling dataset comprises:
detecting the device failure based on real time monitoring data associated with the group of storage devices and a plurality of device failure prediction models, wherein the respective device failure prediction models are trained with benchmark data and historical monitoring data associated with the plurality of storage devices.

18. A computer program product, comprising a computer readable storage medium having program instructions embodied therewith, the program instructions executable by a one or more processors to cause the one or more processors to perform actions of:
performing phase-based predictions on a plurality of storage devices to determine a plurality of sampling scopes and corresponding sampling ratios, wherein the respective sampling scopes comprise at least one storage device of the plurality of storage devices; and
obtaining a sampling dataset by selecting a group of storage devices from the respective sampling scopes with the corresponding sampling ratios; and
detecting device failure for the group of storage devices based on the sampling dataset.

19. The computer program product according to claim 18, wherein performing the phase-based predictions on the plurality of storage devices comprises:
performing the phase-based predictions based on real time monitoring data associated with the plurality of storage devices and a plurality of models,
wherein the respective models are trained with benchmark data and historical monitoring data associated with the plurality of storage devices.

20. The computer program product according to claim 18, wherein the phase-based predictions comprise at least two phases of predictions;
wherein a next phase of prediction is performed based on a result of a previous phase of prediction.
